(19) United States
(12) Patent Application Publication
(10) Pub. No.: US 2019/0363320 A1
(43) Pub. Date: Nov. 28, 2019

(54) CELL CARTRIDGE

(71) Applicant: Gwang Ho Yang, Incheon (KR)

(72) Inventor: Gwang Ho Yang, Incheon (KR)

(73) Assignee: V-ENS CO., LTD., Incheon (KR)

(21) Appl. No.: 13/582,694

(22) PCT Filed: Mar. 3, 2011
(86) PCT No.: PCT/KR2011/001455

§ 371 Date: Dec. 11, 2015

(30) Foreign Application Priority Data
Mar. 5, 2010 (KR) 10-2010-0019994
Mar. 5, 2010 (KR) 10-2010-0019995
Jul. 9, 2010 (KR) 10-2010-0066339

(51) Int. Cl. H01M 2/10; H01M 10/613; H01M 2/24

(52) U.S. Cl. CPC H01M 2/1077; H01M 2/24; H01M 10/613

(57) ABSTRACT

According to an embodiment of the present invention, a cell cartridge comprises: a unit cell module which is formed with a plurality of unit cells that generate currents; a plurality of terminal unit modules which are equipped in the unit cell module; a cartridge center in which the unit cell module is accommodated, and which is formed with a plurality of terminal unit module-mounting parts combined with the plurality of terminal unit modules; a voltage detection connector which is equipped in the cartridge center, and receives the currents of the unit cell module in contact with each terminal module; and a plurality of nut plates which are coupled with the terminal unit module-mounting parts, and are contacted with the voltage detection connector.

### TECHNICAL FIELD

The present invention relates to a cell cartridge, and more particularly to a cell cartridge with improved coupling and structure.

### BACKGROUND ART

One of the biggest problems caused by vehicles using fossil fuel, such as gasoline and diesel, is the creation of air pollution. A technology of using a secondary battery, which can be charged and discharged, as a power source for vehicles has attracted considerable attention as one method of solving such a problem. As a result, electric vehicles (EV), which are operated using only a battery, and hybrid electric vehicles (HEV), which cooperatively use a battery and a conventional engine, have been developed. Some electric vehicles and hybrid electric vehicles are now being commercially used. A nickel metal hydride (Ni-MH) secondary battery has mainly been used as the power source for electric vehicles (EV) and hybrid electric vehicles (HEV). In recent years, however, the use of a lithium ion battery has been attempted.

High power and capacity are needed for such a secondary battery to be used as the power source for electric vehicles (EV) and hybrid electric vehicles (HEV). To this end, a plurality of small-sized secondary batteries (unit cells) is connected to each other in series and/or in parallel so as to constitute a middle or large-sized battery pack.

A prismatic battery or a pouch-shaped battery, which can be stacked with high density to reduce the size of a dead space, is usually used as each of the unit cells constituting the middle or large-sized battery pack. A cell cartridge, in which one or more unit cells are mounted, is generally used to easily achieve mechanical coupling and electrical connection between the unit cells. That is, a plurality of cell cartridges, in each of which unit cells are mounted, is stacked to constitute a battery pack. In each of the cell cartridges, protection, insulation, and heat dissipation of the unit cells mounted therein are required. Also, freedom in stacking or constructing the cell cartridges is required.

### DISCLOSURE

### Technical Problem

It is an object of the present invention to provide a cell cartridge with improved coupling and structure.

Objects of the present invention are not limited by the above object, and those skilled in the art to which the present invention pertains will clearly understand other unmentioned objects from the following description.

### Technical Solution

In order to accomplish the above object, a cell cartridge according to an embodiment of the present invention includes a unit cell module including a plurality of unit cells to generate voltage, a plurality of terminal modules provided at the unit cell module, a cartridge center, in which the unit cell module is mounted, the cartridge center having a plurality of terminal module mounting parts, to which the terminal modules are coupled, a voltage detection connector provided at the cartridge center in contact with the terminal modules to receive current from the unit cell module, and a plurality of nut plates fastened to the terminal module mounting parts, the nut plates being in contact with the voltage detection connector.

Details of other embodiments are included in the detailed description of the invention and the accompanying drawings.

### Advantageous Effects

A cell cartridge according to the present invention has one or more effects as follows.

First, a voltage detection connector is provided at a cartridge center, and therefore, it is possible to reduce man hour necessary to assemble the cell cartridge and to reduce man hour, which may be increased due to complex wires, when the cell cartridge is repaired or replaced.

Second, a conductor is fastened to fastening parts formed at the cartridge center, and therefore, it is possible to prevent the conductor from being damaged by heat generated from a unit cell module due to interference between the unit cell module and the conductor.

Third, a pin connector is provided at the voltage detection connector, and therefore, the coupling between a detection line and the pin connector is securely achieved in a state in which the detection line and the pin connector can be easily detached from each other. Consequently, a problem in that tolerance is increased due to forced fitting is solved. Also, although the unit cell module is defective, the detection line can be reused since the detection line can be detached from the pin connector.

Fourth, terminals are securely fixed to terminal modules by fastening members, and therefore, it is possible to solve a problem in that the transmission of current is not properly achieved due to the occurrence of tolerance when current is transmitted from the unit cell module to the voltage detection connector. Also, it is possible to solve a problem in that the tolerance is further increased due to vibration generated during running of a vehicle.

Fifth, one voltage detection connector is used for each cell cartridge, and therefore, the number of parts is reduced.

Sixth, each terminal module, each nut plate, and each terminal are fastened by one fastening member, and therefore, secure contact among the terminal module, the nut plate, and the terminal is achieved, thereby preventing the occurrence of a short circuit among these elements. Also, the coupling among these elements is simply achieved, thereby reducing man hour and achieving efficient use of a coupling space.

Seventh, a coupling part formed at one side of the nut plate in a protruding fashion is provided with a screw thread corresponding to that formed at the outside of the fastening member so that the coupling part is screw coupled to the fastening member. Consequently, the nut plate and the fastening member are securely coupled to each other by the screw coupling, thereby achieving secure coupling among the terminal module, the nut plate, and the terminal.

Eighth, the inside of the nut plate is bent into a shape of ‘[’. When the inside of the nut plate is fastened to the terminal module mounting part, therefore, the terminal module mounting part supports the inside of the nut plate to securely fix the nut plate.

Ninth, the terminal module mounting part is provided with a terminal receiving part, which is depressed so as to correspond to the shape of the terminal so that the terminal can be located at the terminal receiving part, and therefore, it is possible to prevent the terminal from being separated from the terminal receiving part, thereby achieving secure coupling between the terminal and the terminal module mounting part.

Tenth, the terminal receiving part supports one side of a protrusion of the terminal to prevent rotation of the terminal when the terminal is coupled by the fastening member.

Eleventh, a cartridge inner rib supports the terminal to prevent the terminal from being distorted by the screw fastening and to prevent separation between the terminal and the electrode as the result of such distortion.

Twelfth, the cartridge inner rib supports the terminal to prevent the terminal and the electrode from being separated from each other due to mechanical vibration.

Thirteenth, a corresponding plane is disposed in contact with an inclined plane to further support the electrode in addition to the cartridge inner rib supporting the electrode.

Fourteenth, an electrode support part supports the electrode, and the electrode support part and the cartridge inner rib press the electrode and the terminal from outsides thereof so that the electrode and the terminal are kept in contact with each other.

The effects of the present invention are not limited to the above-mentioned effects, and it will be apparent to those skilled in the art to which the present invention pertains that other unmentioned effects will be understood from the appended claims.

### DESCRIPTION OF DRAWINGS

FIG. 1 is an exploded perspective view showing a cell cartridge according to an embodiment of the present invention;

FIGS. 2 to 5 are views showing a unit cell of the cell cartridge according to the embodiment of the present invention;

FIG. 6 is an exploded perspective view of the cell cartridge according to the embodiment of the present invention;

FIG. 7 is a view showing that a portion of the cell cartridge shown in FIG. 6 is coupled;

FIG. 8 is a view showing that the portion of the cell cartridge shown in FIG. 7 is coupled with the remaining portion of the cell cartridge;

FIG. 9 is a view showing the coupling of the cell cartridge according to the embodiment of the present invention;

FIG. 10 is an exploded perspective view of part A shown in FIG. 7;

FIG. 11 is a sectional view of part A-A shown in FIG. 9;

FIG. 12 is a view showing one side of the cell cartridge according to the embodiment of the present invention;

FIG. 13 is a view showing the other side of the cell cartridge according to the embodiment of the present invention;

FIG. 14 is a perspective view of section B-B′ shown in FIG. 9; and

FIG. 15 is a plan view in which the section shown in FIG. 14 is vertically symmetrized.

### BEST MODE

Advantages and features of the present invention and a method of achieving the advantages and features of the present invention will be clearly understood from embodiments described hereinafter in conjunction with the accompanying drawings. However, the present invention is not limited to the following embodiments and may be realized in various different forms. These embodiments are provided only to completely disclose the present invention and for a person having ordinary skill in the art to which the present invention pertains to completely understand the category of the invention. That is, the present invention is defined only by the category of the claims. The same reference numbers will be used throughout this specification to refer to the same parts.

Hereinafter, preferred embodiments of the present invention will be described in detail with reference to the accompanying drawings illustrating a cell cartridge.

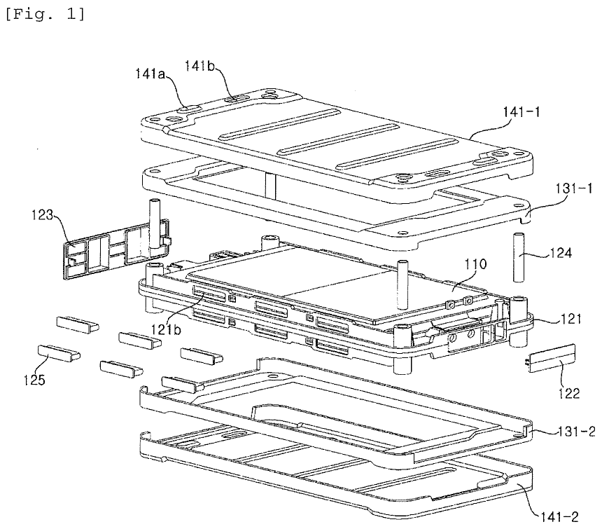

FIG. 1 is an exploded perspective view showing a cell cartridge according to an embodiment of the present invention.

The cell cartridge according to the embodiment of the present invention includes a unit cell module 110, an upper side cartridge inner 131-1, a lower side cartridge inner 131-2, a cartridge center 121, an upper side cover 141-1, and a lower side cover 141-2.

The unit cell module 110 includes a plurality of unit cells. Each of the unit cells is a nickel metal hydride (Ni-MH) cell or a lithium ion (Li-ion) cell to generate current. The unit cell module 110 is mounted in the cartridge center 121. The upper side cartridge inner 131-1 is disposed in tight contact with the edge of the top of the unit cell module 110, and the upper side cover 141-1 is disposed in tight contact with the middle portion of the top of the unit cell module 110. The lower side cartridge inner 131-2 is disposed in tight contact with the edge of the bottom of the unit cell module 110, and the lower side cover 141-2 is disposed in tight contact with the middle portion of the bottom of the unit cell module 110.

The upper side cover 141-1 is disposed in contact with the top of the unit cell module 110 to dissipate heat from the unit cell module 110. The upper side cover 141-1 is preferably formed of an aluminum material exhibiting high heat dissipation. The upper side cartridge inner 131-1 is disposed between the upper side cover 141-1 and the unit cell module 110.

The upper side cartridge inner 131-1 is disposed in contact with the edge of the top of the unit cell module 110. The upper side cartridge inner 131-1 insulates the edge of the top of the unit cell module 110 from the upper side cover 141-1 to prevent direct contact between the edge of the top of the unit cell module 110 and the upper side cover 141-1. The upper side cartridge inner 131-1 supports the edge of the top of the unit cell module 110 and the upper side cover 141-1 between the edge of the top of the unit cell module 110 and the upper side cover 141-1 to protect the edge of the top of the unit cell module 110.

The lower side cover 141-2 and the lower side cartridge inner 131-2 are configured in the same manner as in the above description, and therefore, a detailed description thereof will be omitted.

Convex parts 141a and concave parts 141b are formed at the upper side cover 141-1 and the lower side cover 141-2. The convex parts 141a and the concave parts 141b are coupled to each other, when cell cartridges are stacked, to fix the cell cartridges in place. The convex parts 141a and the concave parts 141b are formed at four corners of the top of the upper side cover 141-1 in a symmetrical fashion to enable forward direction stacking in which the cell cartridges are stacked in the forward direction and reverse direction stacking in which the cell cartridges are stacked in the reverse direction.

The unit cell module 110 is mounted in the cartridge center 121. The upper side cover 141-1 is coupled to the upper side of the cartridge center 121 via the upper side cartridge inner 131-1. The lower side cover 141-2 is coupled to the lower side of the cartridge center 121 via the lower side cartridge inner 131-2. The coupling may be achieved by bonding, bolting, welding, etc.

The cartridge center 121 is provided with spacers 124 to support the upper side cartridge inner 131-1, the upper side cover 141-1, the lower side cartridge inner 131-2, and the lower side cover 141-2. When the cell cartridges are stacked, long bolts are inserted through the spacers 124 to couple the cell cartridges to each other.

Cartridge supports 125 are fitted in side holes 121b formed at the cartridge center 121. The cartridge supports 125 support the edge of the unit cell module 110 to protect the unit cell module 110.

A cover front 123 is coupled to the front of the cartridge center 121, and a cover rear 122 is coupled to the rear of the cartridge center 121, to protect terminal modules (not shown) of the unit cell module 110.

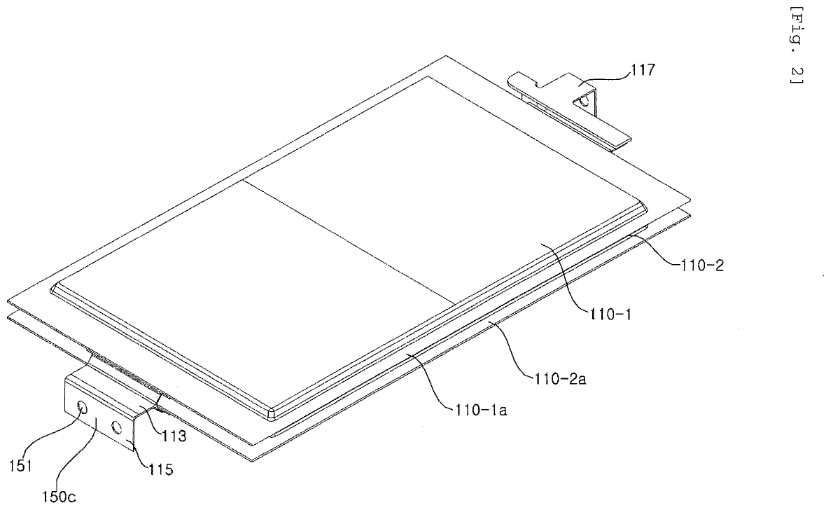

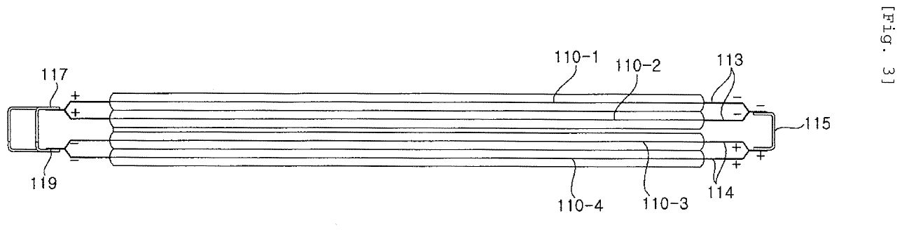

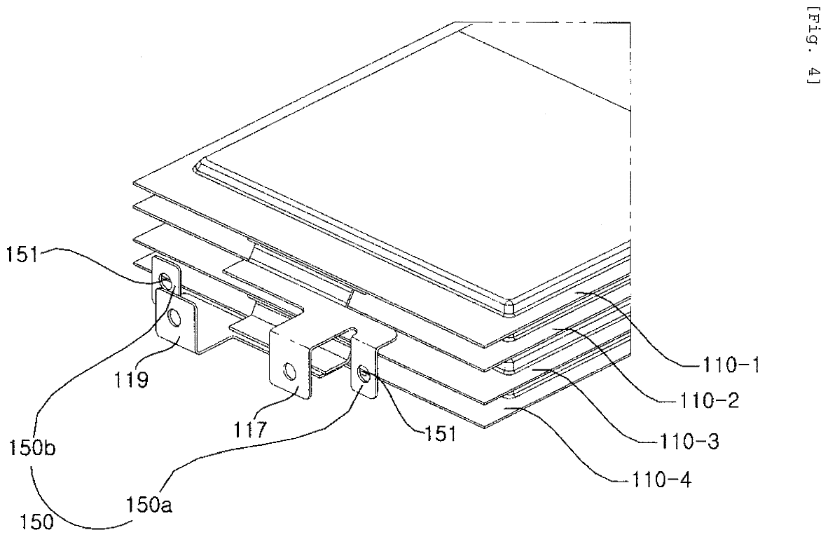

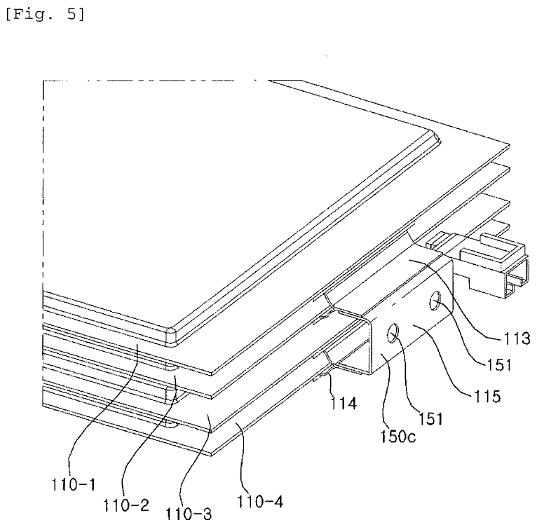

FIGS. 2 to 5 are views showing the unit cell module 110 of the cell cartridge according to the embodiment of the present invention.

The unit cell module 110 preferably includes four unit cells, i.e. a first unit cell 110-1 to a fourth unit cell 110-4. However, the number of the unit cells may be changed depending upon the shape of each of the unit cells.

The first unit cell 110-1 and the second unit cell 110-2 are coupled to each other in a tight contact fashion, and the third unit cell 110-3 and the fourth unit cell 110-4 are coupled to each other in a tight contact fashion. A gap is formed between the second unit cell 110-2 and the third unit cell 110-3. The gap between the second unit cell 110-2 and the third unit cell 110-3 is formed by the cartridge center 121. The gap between the second unit cell 110-2 and the third unit cell 110-3 is provided to allow swelling of the unit cells during charging and discharging of the unit cells. A heat sensor may be disposed in the gap between the second unit cell 110-2 and the third unit cell 110-3.

A first unit cell sealing part 110-1a is a portion to seal the edge of the first unit cell 110-1. If the first unit cell sealing part 110-1a is torn or broken, electrical conduction may occur due to leakage of liquid. Consequently, the first unit cell sealing part 110-1a is disposed in tight contact with the upper side cartridge inner 131-1 so that the first unit cell sealing part 110-1a can be insulated and protected.

The cartridge supports 125 are disposed between the first unit cell sealing part 110-1a and a second unit cell sealing part 110-2a to support, protect, and insulate the respective sealing parts. In particular, the cartridge supports 125 prevent the occurrence of electrical conduction due to leakage of liquid caused by damage to, such as partial tear or breakage of, the first unit cell sealing part 110-1a and the second unit cell sealing part 110-2a, coming into contact with the upper side cartridge inner 131-1 due to drooping of the first unit cell sealing part 110-1a and the second unit cell sealing part 110-2a by gravity in a state in which the cell cartridge is erected vertically, due to vibration of a vehicle.

The unit cell module 110 includes a positive parallel electrode terminal 117, a negative parallel electrode terminal 119, a negative parallel electrode 113, a positive parallel electrode 114, and a serial electrode 115.

The positive parallel electrode terminal 117 interconnects the first unit cell 110-1 and the second unit cell 110-2 in parallel to form an anode of the unit cell module 110. The positive parallel electrode terminal 117 is disposed at one side of the unit cell module 110. The negative parallel electrode terminal 119 interconnects the third unit cell 110-3 and the fourth unit cell 110-4 in parallel to form a cathode of the unit cell module 110. The negative parallel electrode terminal 119 is disposed at one side of the unit cell module 110 in parallel with the positive parallel electrode terminal 117.

The negative parallel electrode 113 interconnects the first unit cell 110-1 and the second unit cell 110-2 in parallel. The positive parallel electrode 114 interconnects the third unit cell 110-3 and the fourth unit cell 110-4 in parallel. The serial electrode 115 interconnects the negative parallel electrode 113 and the positive parallel electrode 114.

The first unit cell 110-1 and the second unit cell 110-2 are connected to each other in parallel, and the third unit cell 110-3 and the fourth unit cell 110-4 are connected to each other in parallel. The two sets of unit cells are connected to each other in series. Consequently, the unit cell module 110 has a two parallel and two series structure. However, the connection structure of the unit cell module may be changed depending upon required voltage and capacity.

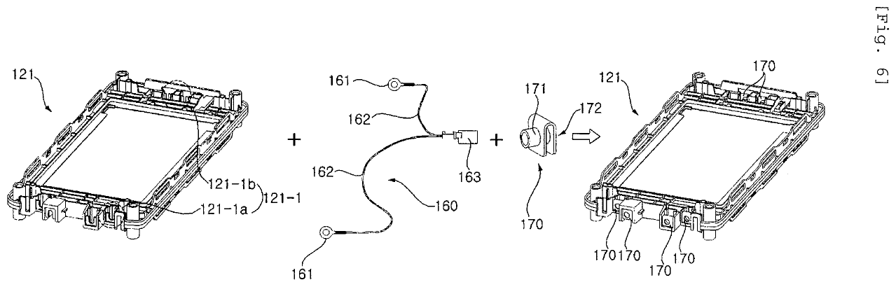

A plurality of terminal modules 150a to 150c to transmit voltage generated by the unit cell module 110 is provided at one side of the unit cell module 110. The terminal modules 150a to 150c may be provided at one side of the serial electrode 115, the negative parallel electrode terminal 119, or the positive parallel electrode terminal 117. Alternatively, the respective electrodes may function as the terminal modules 150a to 150c. In the following description, the serial electrode 115 functions as the terminal module 150c, and the terminal modules 150a and 150b are provided at one side of the negative parallel electrode terminal 119 and/or the positive parallel electrode terminal 117; however, the idea of the present invention is not limited thereto. Functions and coupling relations of the terminal modules 150a to 150c will hereinafter be described with reference to FIG. 6 and the following drawings.

Each of the terminal modules 150a to 150c has a terminal module hole 151. Fastening members 180, which will be described below, are inserted through the terminal module holes 151 so that the terminal modules 150a to 150c are fastened to the cartridge center 121. Coupling relations thereof will be described in detail below.

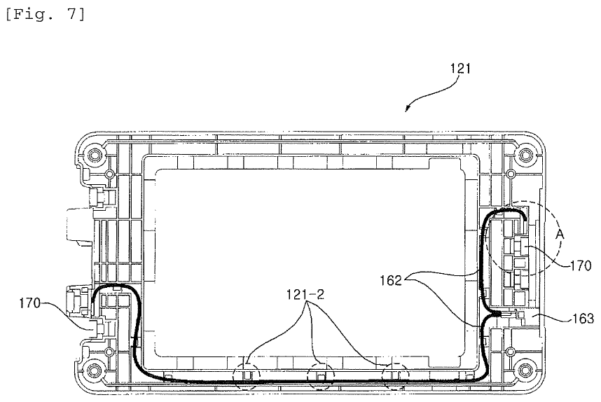

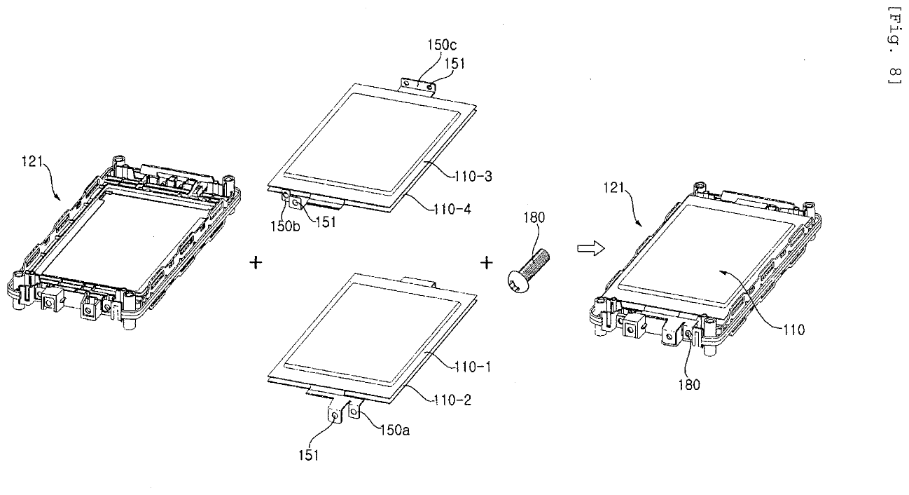

FIG. 6 is an exploded perspective view of the cell cartridge according to the embodiment of the present invention, FIG. 7 is a view showing that a portion of the cell cartridge shown in FIG. 6 is coupled, FIG. 8 is a view showing that the portion of the cell cartridge shown in FIG. is coupled with the remaining portion of the cell cartridge.

Referring to FIGS. 6 to 8, the cell cartridge according to the embodiment of the present invention includes a unit cell module 110 including a plurality of unit cells to generate voltage, a plurality of terminal modules 150a to 150c provided at the unit cell module 110, a cartridge center 121, in which the unit cell module 110 is mounted, the cartridge center 121 having a plurality of terminal module mounting parts 121-1a and 121-1b, to which the terminal modules 150a to 150c are coupled, a voltage detection connector 160 provided at the cartridge center 121 in contact with the terminal modules 150a to 150c to receive current from the unit cell module 110, and a plurality of nut plates 170 fastened to the terminal module mounting parts 121-1a and 121-1b, the nut plates 170 being in contact with the voltage detection connector 160.

As described above, the terminal modules 150a to 150c are provided at the unit cell module 110. The terminal modules 150a to 150c receive current generated by the unit cell module 110 and transmit the current to a battery management system (BMS), which measures current and voltage of each of the unit cells based on the received current value.

The unit cell module 110 is mounted in the cartridge center 121. The terminal module mounting parts 121-a and 121-1b, to which the terminal modules 150a to 150c are coupled, are formed at the cartridge center 121. The terminal module mounting parts 121-1a and 121-1b may be formed integrally with the cartridge center 121. The terminal module mounting parts 121-1a and 121-1b may be depressed so that the terminal modules 150a to 150c are mounted to the terminal module mounting parts 121-1b and 121-1b; however, the shape of the terminal module mounting parts 121-1a and 121-1b is not limited thereto.

The terminal module mounting parts 121-1a and 121-1b are formed at the cartridge center 121 so as to correspond to the terminal modules 150a to 150c so that the terminal modules 150a to 150c are mounted to the terminal module mounting parts 121-1a and 121-1b.

The voltage detection connector 160 is provided at the cartridge center 121. The voltage detection connector 160 may be provided at the inside of the cartridge center 121. In a case in which the voltage detection connector 160 is provided at the inside of the cartridge center 121, complex wires are not provided at the outside of the cell cartridge. As a result, man hour necessary to assemble the cell cartridge is reduced. Also, when the cell cartridge is repaired or replaced due to malfunction of the cell cartridge, man hour, which may be increased due to complex wires, is reduced.

The voltage detection connector 160 is disposed in contact with the terminal modules 150a to 150c to receive current from the unit cell module 110. The voltage detection connector 160 is provided at the inside of the cartridge center 121 in contact with the terminal modules 150a to 150c. The voltage detection connector 160 is disposed in contact with the terminal modules 150a to 150c to transmit current generated by the unit cell module 110 to the battery management system.

The battery management system measures current or voltage of the unit cell module 110 based on the amount of the current received from the voltage detection connector 160. Based on result values of the measured current or voltage, the battery management system controls the charge amount or the discharge amount of the unit cell module 110, when the unit cell module 110 has been overdischarged or overcharged, so that the unit cell module 110 can be normally charged or discharged.

The voltage detection connector 160 is provided at opposite sides thereof with terminals 161 to receive current. The respective terminals 161 are connected to each other via a conductor 162. The terminals 161 of the voltage detection connector 160 are disposed in contact with the terminal modules 150a to 150c. Each of the terminals 161 may be formed in the shape of an 0-ring having a hole formed in the center thereof. Alternatively, each of the terminals 161 may be formed in the shape of a rectangle having a hole formed in the center thereof. In the following description, each of the terminals 161 is formed in the shape of an O-ring; however, the idea of the present invention is not limited thereto.

The terminals 161 are disposed in contact with the terminal modules 150a to 150c. In a case in which one of the terminals 161 is disposed in contact with the serial electrode 115, the other terminal 161 is disposed in contact with the terminal modules 150a to 150c provided at one side of the negative parallel electrode terminal 119 or the positive parallel electrode terminal 117.

The current is transmitted from the terminals 161 to the conductor 162 connected to the terminals 161. The conductor 162 is generally formed of an electric wire although the conductor 162 may include all kinds of conducting wires that can transmit current.

The conductor 162 is fastened to a plurality of fastening parts 121-2 provided at the cartridge center 121. The fastening parts 121-2 are formed at the cartridge center 121 to fixedly fasten the conductor 162. The conductor 162 is fixedly fastened to the fastening parts 121-2. Since the conductor 162 is fastened to the fastening parts 121-2, it is possible to prevent the conductor 162 from being damaged by heat generated from the unit cell module 110 due to interference between the unit cell module 110 and the conductor 162.

The conductor 162 is provided with a pin connector 163 to transmit the current received from the respective terminals 161. The pin connector 163 is a kind of connector to transmit the current received from the respective conductors 162 to the battery management system. The pin connector 163 is coupled to the conductor 162 using various methods, such as soldering and forced fitting.

The pin connector 163 is configured so that a detection line 200 (see FIG. 13) to transmit current from the unit cell module 110 to the battery management system is coupled to the pin connector 163. In this case, the coupling between the detection line 200 and the pin connector 163 is securely achieved in a state in which the detection line 200 and the pin connector 163 can be easily detached from each other. Consequently, a problem in that tolerance is increased due to forced fitting is solved. Also, although the unit cell module 110 is defective, the detection line 200 can be reused since the detection line 200 can be detached from the pin connector 163.

The nut plates 170 are fastened to the terminal module mounting parts 121-1a and 121-1b. The nut plates 170 are formed so as to correspond to the terminal module mounting parts 121-1a and 121-1b so that the nut plates 170 can be fastened to the terminal module mounting parts 121-1a and 121-1b. Each of the nut plates 170 has a nut plate hole 172 formed therethrough so that a fastening member 180, which will be described below, is fastened through the nut plate hole 172.

When looking into the coupling relations of the cell cartridge shown in FIGS. 6 to 8, each of the terminal modules 150a to 150c, each of the terminals 161, and each of the nut plates 170 are fastened to a corresponding one of the terminal module mounting parts 121-1a and 121-1b by a corresponding one of the fastening members 180 inserted through each of the terminal modules 150a to 150c, each of the terminals 161, and each of the nut plates 170.

A terminal module hole 151 is formed at each of the terminal modules 150a to 150c so that a corresponding one of the fastening members 180 is fastened through the terminal module hole 151. In a case in which each of the terminals 161 is formed in the shape of an O-ring, a hole is formed in the center of each of the terminals 161 so that a corresponding one of the fastening members 180 is fastened through the hole. As previously described, the nut plate hole 172 is formed in the center of each of the nut plates 170. A hole is formed in the center of each of the terminal module mounting parts 121-1a and 121-1b so that a corresponding one of the fastening members 180 is fastened through the hole.

When looking into the coupling relations based on the above-stated construction, the voltage detection connector 160 is fastened to the cartridge center 121. One of the terminals 161 of the voltage detection connector 160 is fastened to a corresponding one of the terminal module mounting parts 121-1a and 121-1b.

In a state in which the terminals 161 are fastened to the terminal module mounting parts 121-1a and 121-1b, the nut plates 170 are fastened to the terminal module mounting parts 121-1a and 121-1b. The nut plates 170 fix the terminals 161 to the terminal module mounting parts 121-1a and 121-1b. In a state in which the nut plates 170 are fastened to the terminal module mounting parts 121-1a a and 121-1b, the unit cell module 110 is fastened to the cartridge center 121. The terminal modules 150a to 150c of the unit cell module 110 are disposed in contact with the nut plates 170.

In a state in which the terminal modules 150a to 150c, the terminals 161, and the nut plates 170 are mounted to the terminal module mounting parts 121-1a and 121-1b, the fastening members 180 are inserted and fastened through the terminal module holes 151, the nut plate holes 172, the holes formed in the terminals 161, and the holes formed in the terminal module mounting parts 121-1a and 121-1b. Each of the fastening members 180 may be formed of a bolt, a screw, a pin, or a rivet, which is inserted and fastened through the above-mentioned holes. In the following description, each of the fastening members 180 is formed of a screw, which is screw coupled in the above-mentioned holes; however, the fastening members 180 are not limited thereto.

The terminals 161 are securely fixed to the terminal modules 150a to 150c by the fastening members 180, thereby solving a problem in that tolerance occurs. Since the terminals 161 are securely fixed to the terminal modules 150a to 150c, it is possible to solve a problem in that the transmission of current is not properly achieved due to the occurrence of tolerance when current is transmitted from the unit cell module 110 to the voltage detection connector 160. Also, it is possible to prevent the occurrence of a problem in that the tolerance is further increased due to vibration generated during the operation of a vehicle.

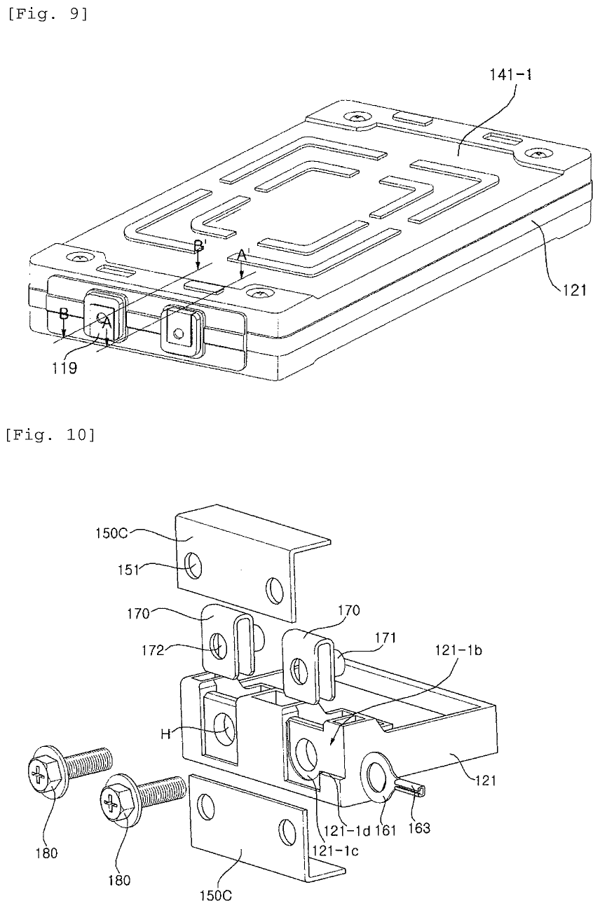

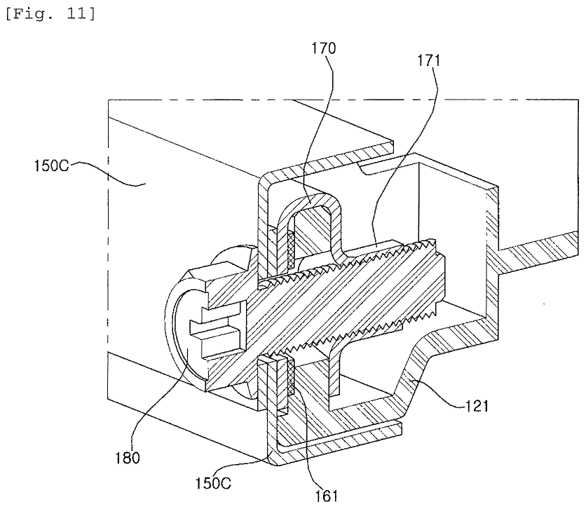

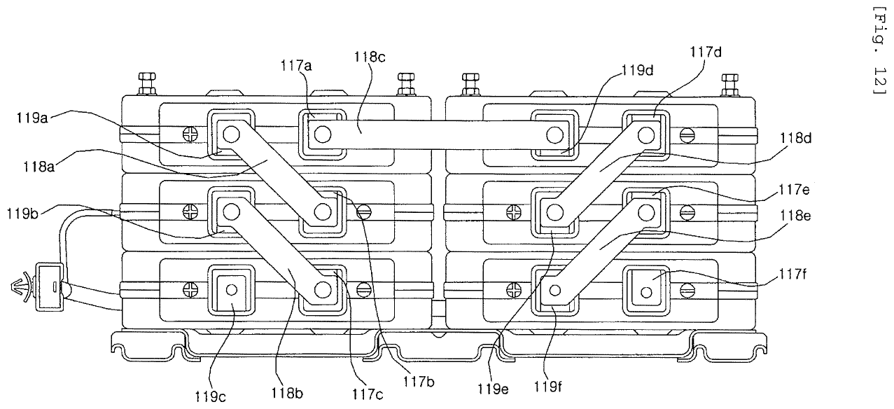

FIG. 9 is a view showing the coupling of the cell cartridge according to the embodiment of the present invention, FIG. 10 is an exploded perspective view of part A shown in FIG. 7, and FIG. 11 is a sectional view of part A-A shown in FIG. 9.

When looking into the coupling relations of the cell cartridge shown in FIGS. 9 to 11, the nut plates 170 are fastened to the terminal module mounting parts 121-1a and 121-1b, and the terminal modules 150a to 150c are disposed in contact with the outsides of the nut plates 170 so that current from the terminal modules 150a to 150c is transmitted to the nut plates 170. The terminals 161 are located at the terminal module mounting parts 121-1a and 121-1b in contact with the nut plates 170 to receive current from the nut plates 170.

As previously described, a plurality of terminal modules 150a to 150c is provided. Hereinafter, only the terminal module 150c provided at one side will be described; however, the idea of the present invention is not limited thereto. Also, only the terminal module mounting part 121-1b, to which the terminal module 150c is coupled, will be described; however, the idea of the present invention is not limited thereto.

The nut plate 170 is fastened to the terminal module mounting part 121-1b. In the following description, the nut plate 170 is bent twice into a shape of ‘[’ so that the nut plate 170 can be fitted onto the terminal module mounting part 121-1a or 121-1b; however, the shape of the nut plate 170 is not limited thereto.

The inside of the nut plate 170 is the inner part formed by bending the nut plate 170 into a shape of ‘[’. The inside of the nut plate 170 is fastened to the terminal module mounting part 121-1b. When the inside of the nut plate 170 is fastened to the terminal module mounting part 121-1b, the terminal module mounting part 121-1b supports the bent inside of the nut plate 170 to fix the nut plate 170.

The terminal module 150c is disposed in contact with the outside of the nut plate 170. The terminal module 150c transmits current generated by the unit cell module 110 to the nut plate 170. At this time, one terminal module 150c and another terminal module 150c may be in contact with the nut plate in an aligned state. One terminal module 150c is disposed in contact with the outside of the nut plate 170 so that current generated by the unit cell module 110 can be transmitted to the nut plate 170.

According to embodiments, each terminal 161 may be formed in the shape of an O-ring having a hole H formed in the center thereof. Alternatively, the terminal 161 may be formed in the shape of a rectangle having a hole H formed in the center thereof. In the following description, the terminal 161 is formed in the shape of an O-ring; however, the idea of the present invention is not limited thereto.

The terminal 161 is located at the terminal module mounting part 121-1b. The terminal module mounting part 121-1b is provided with a terminal receiving part 121-1c, which is depressed so as to correspond to the shape of the terminal 161 so that the terminal 161 can be located at the terminal receiving part 121-1c. The terminal 161 is located at the terminal receiving part 121-1c, which is a depressed part, so that the terminal 161 is not separated from the terminal receiving part 121-1c, thereby achieving secure coupling between the terminal 161 and the terminal module mounting part 121-1b.

A rectangular protrusion 163, which is connected to the conductor, may be formed at one side of the terminal 161 in an extended state. The protrusion 163 is formed of the same material as the terminal 161. The protrusion 163 may be coupled to the conductor using various methods, such as welding, soldering, and forced fitting.

The terminal receiving part 121-1c is provided with a terminal support part 121-1d, which supports one side of the protrusion 163 of the terminal 161 to prevent rotation of the terminal 161 when the terminal 161 is coupled by the fastening member 180. The terminal 161 is coupled by the fastening member 180. At this time, the fastening member 180 and the nut plate 180 are coupled to each other by screw coupling, and the terminal 161, through which the fastening member 180 is inserted, may be rotated by the rotation of the fastening member 180. In this case, the terminal support part 121-1d supports the protrusion 163 to prevent the rotation of the terminal 161.

The terminal support part 121-1d is depressed so as to correspond to the shape of the protrusion 163 when the terminal 161 is received in the terminal module mounting part 121-1b. A step is formed at one side of the terminal support part 121-1d. The step serves as the terminal support part 121-1d to support the protrusion 163.

The terminal 161 is received at the ‘[’-shaped inside of the nut plate 170. That is, the terminal 161 is provided between the inside of the nut plate 170 and the terminal module mounting part 121-1b so that one side of the terminal 161 is located at the terminal module mounting part 121-1b, and the other side of the terminal 161 is disposed in contact with the inside of the nut plate 170.

The terminal 161 transmits current, received from the nut plate 170, with which the terminal 161 is in contact, to the detection line 200 (see FIG. 13) provided at the outside via the voltage detection connector 160. The current is finally transmitted to the battery management system.

The terminal 161 is located at only one of the terminal module mounting parts 121-1b. When current is transmitted from the terminal module 150c to the terminal 161 via the nut plate 170, it is possible for the terminal 161, which is located at one of the terminal module mounting parts 121-1b, to receive current from the unit cell module 110 via the terminal module 150c coupled to the terminal module mounting part 121-1b. Consequently, it is sufficient for the terminal 161 to be provided at only one terminal module mounting part 121-1b.

The terminal module 150c, the nut plate 170, and the terminal module mounting part 121-1b have holes, which are coaxially aligned. A terminal module hole 151 is formed at the terminal module 150c, and a nut plate hole 172 corresponding to the terminal module hole 151 is formed at the nut plate 170. A coupling part 171 of the nut plate 170 is also provided with a hole coaxially aligned with the terminal module hole 151 so as to correspond to the terminal module hole 151. A screw thread is formed at the inside of the hole of the coupling part. In this embodiment, as described above, the terminal 161 is formed in the shape of an O-ring having a hole formed in the center thereof.

When explaining the coupling relations based on the above description, first, the terminal 161 is located at the terminal module mounting part 121-1b. The terminal is located at the terminal receiving part 121-1c formed at the terminal module mounting part 121-1b, and the protrusion 163 of the terminal 161 is supported by the terminal support part 121-1d. At this time, the holes H formed at the terminal 161 and the terminal module mounting part 121-1b are aligned with each other so that the fastening member 180 can be inserted through the holes.

In a state in which the terminal 161 is located at the terminal module mounting part 121-1b, the nut plate 170 is fastened. Since the nut plate 170 is formed in the shape of ‘[’, the terminal module mounting part 121-1b and the terminal 161 are received at the inside of the nut plate 170, and the terminal 161 is disposed in contact with the inside of the nut plate 170. The nut plate hole 172 of the nut plate 170 is coaxially disposed so that the fastening member 180 can be inserted through the terminal module mounting part 121-1b and the terminal 161.

The fastening member 180 is inserted through the terminal module hole 151, the hole H of the nut plate 170, and the holes H of the terminal 161 and the terminal module mounting part 121-1b, and is then screw coupled to the coupling part 171 of the nut plate 170. The fastening member 180 is inserted through the above-mentioned holes H to integrally fasten the above-mentioned elements.

The coupling part 171 is formed at one side of the nut plate 170 in a protruding fashion. At the inside of the coupling part 171 is formed a screw thread corresponding to that formed at the outside of the fastening member 180. Consequently, the coupling part 171 is screw coupled to the fastening member 180. The nut plate 170 and the fastening member 180 are securely coupled to each other by the fastening member 180, and therefore, secure contact among the terminal module 150c, the nut plate 170, and the terminal 161 is achieved, thereby preventing the occurrence of a short circuit.

As the terminal module 150c, the nut plate 170, and the terminal 161 are securely coupled to one another in tight contact by the fastening member 180, the occurrence of a short circuit among these elements is prevented. Also, the coupling among these elements is simply achieved, thereby reducing man hour and achieving efficient use of a coupling space.

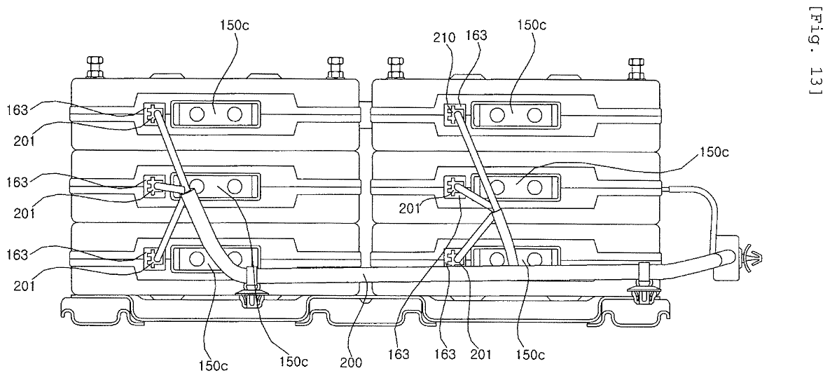

FIG. 12 is a view showing one side of the cell cartridge according to the embodiment of the present invention, and FIG. 13 is a view showing the other side of the cell cartridge according to the embodiment of the present invention.

Referring to FIGS. 12 and 13, a plurality of cell cartridges is stacked in the same direction, and negative parallel electrode terminals 119a to 119f and positive parallel electrode terminals 117a to 117f are disposed in a line. The first negative parallel electrode terminal 119a is connected to the second positive parallel electrode terminal 117b, which is diagonally opposite to the first negative parallel electrode terminal 119a, via a first connector 118a. The second negative parallel electrode terminal 119b is connected to the third positive parallel electrode terminal 117c, which is diagonally opposite to the second negative parallel electrode terminal 119b, via a second connector 118b. The third negative parallel electrode terminal 119c, which is a negative parallel electrode terminal disposed at the lowermost layer of a stack of the cell cartridges, is not connected to any positive parallel electrode terminal. The fourth negative parallel electrode terminal 119d, which is a negative parallel electrode terminal disposed at the uppermost layer of the stack of the cell cartridges, is connected to the first positive parallel electrode terminal 117a, which is a positive parallel electrode terminal disposed at the uppermost layer of another adjacent stack of the cell cartridges, via a third connector 118c. The fifth negative parallel electrode terminal 119e is connected to the fourth positive parallel electrode terminal 117d via a fourth connector 118d, and the sixth negative parallel electrode terminal 119f is connected to the fifth positive parallel electrode terminal 117e via a fifth connector 118e.

A plurality of connected cell cartridges is connected to another plurality of connected cell cartridges in series to serve as a single current supply unit. In this case, portions which measure current to detect voltage are the negative parallel electrode terminals 119a to 119f or the positive parallel electrode terminals 117a to 117f and the serial electrodes. That is, the negative parallel electrode terminals 119a to 119f are connected to the positive parallel electrode terminals 117a to 117f via the connectors 118a to 118e, and therefore, the negative parallel electrode terminals 119a to 119f or the positive parallel electrode terminals 117a to 117f measure current to detect voltage.

Consequently, the voltage detection connectors 160 according to the embodiment of the present invention are disposed in contact with the serial electrodes 115 and the negative parallel electrode terminals 119a to 119f or the positive parallel electrode terminals 117a to 117f to transmit current to the battery management system.

In FIG. 13, which is a view showing the other side of the stack of the cell cartridges, the detection line 200 is fastened to the pin connectors 163. The voltage detection connectors 160, receiving current from the serial electrodes 115 and the negative parallel electrode terminals 119a to 119f or the positive parallel electrode terminals 117a to 117f, transmits the received current to the detection line 200 through the pin connectors 163. The detection line 200 may include a plurality of conducting wires. At one end of each of the conducting wires is provided a pin connector connection part 201, to which a corresponding one of the pin connectors 163 is fastened. Each of the pin connector connection parts 201 is fastened to a corresponding one of the cell cartridges. In this case, the pin connectors 163 are securely fastened to the corresponding pin connector connection parts 201, thereby solving a problem in that tolerance is increased due to forced fitting. Also, the pin connectors 163 are fastened to the pin connector connection parts 201 using detachable fastening method, not forced fitting. Even when one of the cell cartridges is replaced, it is possible to reuse the detection line 200 as it is. Also, the conducting wires are simply arranged, and therefore, man hour is reduced. In addition, the voltage detection connector 160 is not used for each unit cell but for each cell cartridge, and therefore, the number of parts is reduced.

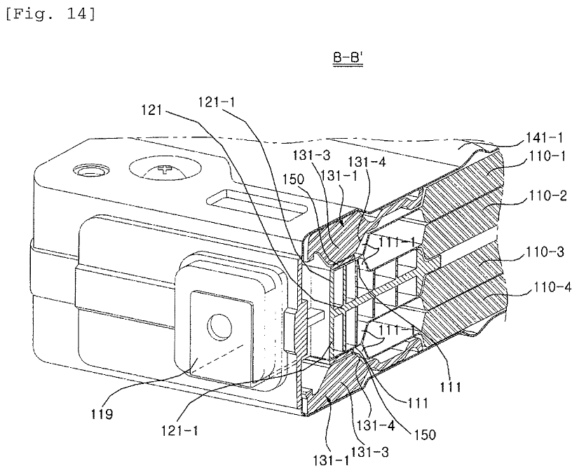

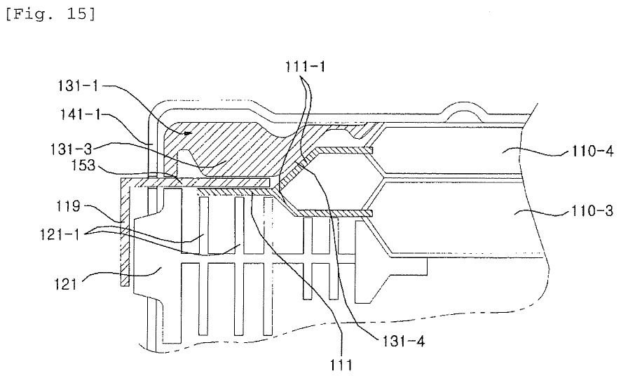

FIG. 14 is a perspective view of section B-B′ shown in FIG. 9, and FIG. 15 is a plan view in which the section shown in FIG. 14 is vertically symmetrized.

Referring to FIGS. 14 and 15, the cell cartridge according to the embodiment of the present invention includes a plurality of unit cells 110 to generate voltage, a plurality of terminal modules 150a to 150c each including an electrode 111 provided at each of the unit cells 110 and a terminal 153 having one side in contact with one side of the electrode 111 to receive current generated by each of the unit cells 110 via the electrode 111, a cartridge center 121, in which the unit cells 110 are mounted, the cartridge center 121 having an electrode support part 121-1 to support the other side of each of the electrodes 111, and a cartridge inner 131-1 or 131-2 having a cartridge inner rib 131-3 to support the other side of each of the terminals 153, the cartridge inner rib 131-3 protruding from the cartridge inner 131-1 or 131-2 so that the cartridge inner rib 131-3 enables the terminal 153 and the electrode 111 to come into contact with each other together with the electrode support part 121-1.

The cartridge inner 131-1 or 131-2 may correspond to the previously-described upper side cartridge inner 131-1 or lower side cartridge inner 131-2.

Each of the terminal modules 150a to 150c includes an electrode 111 and a terminal 153. The electrode 111 is provided at one side of the unit cells 110-1 to 110-4. The electrode 111 may be provided for each of the unit cells 110-1 to 110-4 to transmit current generated by each of the unit cells 110-1 to 110-4. Alternatively, one electrode 111 may be provided for a set of two or more unit cells 110-1 to 110-4. In the following description, one electrode 111 may be provided for a set of two unit cells 110-3 and 110-4; however, the number of the electrodes 111 or the number of the unit cells 110-3 and 110-4 is not limited thereto.

The electrode 111 corresponds to the previously-described positive parallel electrode 114 or negative parallel electrode 113. The shape of the electrode 111 will be described below.

One side of the terminal 153 is disposed in contact with one side of the electrode 111. The terminal 153 is disposed in contact with the electrode 111 to receive current generated by the unit cells 110-3 and 110-4. The terminal 153 may be the positive parallel electrode terminal 117, the negative parallel electrode terminal 119, or the serial electrode 113. In the following description, the terminal 153 is the negative parallel electrode terminal 119; however, the terminal 153 is not limited thereto.

The plurality of unit cells 110 is mounted in the cartridge center 121. The cartridge center 121 is provided at one side thereof with an electrode support part 121-1 to support the other side of the electrode 111. The electrode support part 121-1 may include one or more ribs. In the following description, the electrode support part 121-1 includes a plurality of ribs; however, the idea of the present invention is not limited thereto. The electrode support part 121-1, including the ribs, supports the outer side of the electrode 11. The electrode support part 121-1 may be formed integrally with the cartridge center 121.

The cartridge inner rib 131-3 is formed at the cartridge inner 131-1 or 131-2 in a protruding fashion. The cartridge inner rib 131-3 may be formed integrally with the cartridge inner 131-1 or 131-2. The cartridge inner rib 131-3 supports the other side of the terminal 153. The cartridge inner rib 131-3 enables the terminal 153 and the electrode 111 to come into contact with each other together with the electrode support part 121-1.

When looking into the coupling relations of the above-mentioned elements, one side of the electrode 111 is disposed in contact with one side of the terminal 153, the other side of the electrode 111 is supported by the electrode support part 121-1, and the other side of the terminal 153 is supported by the cartridge inner rib 131-3.

That is, the electrode support part 121-1 and the cartridge inner rib 131-3 press the electrode 111 and the terminal 153 from outsides thereof so that the electrode 111 and the terminal 153 are kept in contact with each other.

The reason that the electrode 111 and the terminal 153 are kept in contact with each other will be described in detail. The terminal 153 may be provided at one side thereof with a fastening hole (not shown). When the terminal 153 is fastened to another external device, screw fastening through the fastening hole is carried out. In this case, the terminal 153 may be distorted by the screw fastening, and separation between the terminal 153 and the electrode 111 may occur as the result of such distortion. When the terminal 153 and the electrode 111 are separated from each other, current generated by the unit cells 110 cannot be transmitted. For this reason, it is necessary to provide a structure which presses the electrode 111 and the terminal 153 to prevent the separation between the terminal 153 and the electrode 111. In this case, the separation between the terminal 153 and the electrode 111 is prevented by the electrode support part 121-1 and the cartridge inner rib 131-3.

The cartridge inner rib 131-3 supports the terminal 153 to prevent the terminal 153 and the electrode 111 from being separated from each other due to vibration. Minute mechanical vibration occurs in a machine or apparatus in which the cell cartridge is mounted, and the electrode 111 and the terminal 153 may be separated from each other due to such vibration. At this time, the electrode support part 121-1 and the cartridge inner rib 131-3 press and support the electrode 111 and the terminal 153 from the outsides thereof, thereby preventing the terminal 153 and the electrode 111 from being separated from each other.

The electrode 111 may be bent in a multiple stepwise fashion to form inclined planes 111-1. To form a plurality of unit cells 110 so as to have a single electrode 111, the electrodes of the unit cells 110 may be combined into the single electrode 111. At this time, the side shape of the electrode 111 may be a curved line or a multiple stepwise straight line. In the following description, the side shape of the electrode 111 is a multiple stepwise straight line; however, the side shape of the electrode 111 is not limited thereto.

The electrode 111 is bent in a multiple stepwise fashion so as to combine two of the unit cells 110-1 to 110-4, e.g. the unit cells 110-3 and 110-4, so that the inclined planes 111-1 are formed. The cartridge inner rib 131-3 has a corresponding plane 131-4 formed so as to correspond to the inclined planes 111-1 of the electrode 111.

The corresponding plane 131-4 is formed at one side of the cartridge inner rib 131-3. The corresponding plane 131-4 is disposed in contact with the inclined planes 111-1 of the electrode 111 to the support the inclined planes 111-1. The corresponding plane 131-4 is preferably disposed in contact with the entirety of the inclined planes 111-1. The corresponding plane 131-4 is disposed in contact with the inclined planes 111-1 to further support the electrode 111 in addition to the cartridge inner rib 131-3 supporting the electrode 111. As a result, the electrode 111 and the terminal 153 are prevented from being separated from each other due to vibration and screw coupling as described above.

Although the preferred embodiments of the present invention have been illustrated and described, the present invention is not limited to the specific embodiments described herein. It will be apparent to those skilled in the art to which the present invention pertains that various modifications and variations can be made in the present invention without departing from the gist of the present invention recited in the claims, and such modifications and variations should not be individually understood from the technical idea or prospect of the present invention.

1. A cell cartridge comprising:
a unit cell module comprising a plurality of unit cells to generate voltage;
a plurality of terminal modules provided at the unit cell module;
a cartridge center, in which the unit cell module is mounted, the cartridge center having a plurality of terminal module mounting parts, to which the terminal modules are coupled;
a voltage detection connector provided at the cartridge center in contact with the terminal modules to receive current from the unit cell module; and
a plurality of nut plates fastened to the terminal module mounting parts, the nut plates being in contact with the voltage detection connector.

2. The cell cartridge according to claim 1, wherein the voltage detection connector comprises a plurality of terminals located at the terminal module mounting parts in contact with the nut plates to receive current from the nut plates.

3. The cell cartridge according to claim 2, wherein each of the terminal modules, each of the terminals, and each of the nut plates are fastened to a corresponding one of the terminal module mounting parts by a fastening member inserted through each of the terminal modules, each of the terminals, and each of the nut plates.

4. The cell cartridge according to claim 2, wherein the voltage detection connector comprises a conductor to interconnect the respective terminals.

5. The cell cartridge according to claim 4, wherein the conductor is provided with a pin connector to transmit current received from the respective terminals.

6. The cell cartridge according to claim 4, wherein the cartridge center is provided with a plurality of fastening parts, to which the conductor is fastened.

7. The cell cartridge according to claim 3, wherein each of the terminal modules has a terminal module hole, through which the fastening member is fastened.

8. The cell cartridge according to claim 3, wherein each of the nut plates has a nut plate hole, through which the fastening member is fastened.

9. The cell cartridge according to claim 2, wherein the terminal modules are disposed in contact with the nut plates, and the terminals are disposed in contact with insides of the nut plates.

10. The cell cartridge according to claim 1, wherein each of the nut plates is provided with a coupling part having a hole, at an inside of one side of which a screw thread is formed.

11. The cell cartridge according to claim 2, wherein each of the nut plates is bent into a shape of ‘[’ so that the terminals are received at ‘[’-shaped insides of the nut plates.

12. The cell cartridge according to claim 1, wherein the terminal modules, the nut plates, and the terminal module mounting parts have holes, which are coaxially aligned.

13. The cell cartridge according to claim 2, wherein each of the terminal module mounting parts is provided with a terminal receiving part, which is depressed so as to correspond to a shape of each of the terminals so that each of the terminals is located at the terminal receiving part.

14. The cell cartridge according to claim 13, wherein
each of the terminals is provided at one side thereof with a rectangular protrusion, which is formed in an extended state, and
the terminal receiving part is provided with a terminal support part which supports one side of the protrusion to prevent each of the terminals from being rotated.

15. The cell cartridge according to claim 2, wherein the terminals are located at only one of the terminal module mounting parts.

16. The cell cartridge according to claim 1, wherein each of the terminal modules comprises:
an electrode connected to each of the unit cells; and
a terminal having one side in contact with one side of the electrode to receive current generated by each of the unit cells via the electrode.

17. The cell cartridge according to claim 16, further comprising:
a cartridge center, in which the unit cells are mounted, the cartridge center having an electrode support part to support the other side of the electrode; and
a cartridge inner having a cartridge inner rib to support the other side of the terminal, the cartridge inner rib protruding from the cartridge inner so that the cartridge inner rib enables the terminal and the electrode to come into contact with each other together with the electrode support part.

18. The cell cartridge according to claim 17, wherein the electrode support part comprises a plurality of ribs.

19. The cell cartridge according to claim 17, wherein the cartridge inner rib supports the terminal to prevent the terminal and the electrode from being separated from each other due to vibration.

20. The cell cartridge according to claim 17, wherein
one side of the electrode is disposed in contact with one side of the terminal,
the other side of the electrode is supported by the electrode support part, and
the other side of the terminal is supported by the cartridge inner rib.

21. The cell cartridge according to claim 17, wherein
The electrode is bent in a multiple stepwise fashion to form an inclined plane, and
the cartridge inner rib has a corresponding plane formed so as to correspond to the inclined plane.
